(19) United States
(12) Patent Application Publication
(10) Pub. No.: US 2025/0123359 A1
(43) Pub. Date: Apr. 17, 2025

(54) OVER-THE-AIR RADAR TEST SYSTEM WITH MODULATION CHANGE DETECTION

(71) Applicant: UniqueSec AB, Hovås (SE)

(72) Inventors: Kasra HAGHIGHI, Hovås (SE); Fahimeh RAFIEINIA, Hovås (SE)

(21) Appl. No.: 18/917,627

(22) Filed: Oct. 16, 2024

(30) Foreign Application Priority Data
Oct. 17, 2023 (SE) 2330465-2

(51) Int. Cl. G01S 7/40; G01S 7/02

(52) U.S. Cl. CPC G01S 7/4008; G01S 7/021

(57) ABSTRACT

A radar modulation parameter detection system (420, 600), comprising
an antenna (610) arranged to receive a radar signal (602) from a radar under test, RUT, (601),
a power detector (620) arranged to determine a temporal power level profile of the received radar signal, and processing circuitry (640),
where the processing circuitry (640) is configured to obtain a record (710) comprising at least two different radar modulation formats, where each radar modulation format in the record is associated with respective radar modulation parameters, and with respective temporal power level profile data entries,
where the processing circuitry (640) is configured to identify a current modulation format in use by the RUT (601) among the at least two different radar modulation formats in the record (710), based on a comparison between the determined temporal power level profile of the received radar signal and the temporal power level profile data entries in the record,
where the radar modulation parameter detection system (420, 600) is arranged to output a radar test system control signal determined based on the current modulation format of the RUT (601).

### TECHNICAL FIELD

This disclosure relates generally to automotive radar systems, and in particular to testing methods, software, and equipment for verifying a function of an automotive radar system. Aspects of the disclosure relate to methods, instruments, and systems for detecting a change in modulation by a radar transceiver under test and adapting one or more operations of a radar test system in response thereto.

### BACKGROUND

Today's vehicles, such as passenger cars and trucks, may use several radars to provide perception of the vehicle's surroundings, which perception is then used in applications such as adaptive cruise control, emergency braking and other comfort and safety functions. The radar systems measure properties such as distance, speed, and radar cross section (RCS) of one or more objects in the vehicle's surroundings. Some more advanced radar systems also measure angle in azimuth and/or in elevation of nearby objects. The objects might be stationary, like road signs, or moving, such as other road users including pedestrians, bicycles, and other vehicles.

There is a need to verify that the automotive radar systems provide the intended function. Towards this end, testing systems are required which are reliable and at the same time also spatially efficient and of low cost.

### SUMMARY

There is disclosed a radar modulation parameter detection system which is able to automatically detect which modulation parameters that are used by a radar under test in an efficient and reliable manner. The system comprises an antenna or at least an antenna port arranged to receive a radar signal from a radar under test (RUT), and also a power detector that is arranged to determine a temporal power level profile of the received radar signal, i.e., how the radar signal power changes over time, such as when it starts and when it stops. The system also comprises processing circuitry that is configured to obtain a record comprising at least two different radar modulation formats, where each radar modulation format in the record is associated with respective radar modulation parameters, and with respective temporal power level profile data entries. The processing circuitry is configured to identify a current modulation format in use by the RUT among the at least two different radar modulation formats in the record, based on a comparison between the determined temporal power level profile of the received radar signal and the temporal power level profile data entries in the record. This way the radar modulation parameter detection system is able to output a radar test system control signal determined based on the current modulation format of the RUT. In essence, the radar modulation parameter detection system uses the temporal power profile of the radar transmission as a key to find the correct entry in the record. Once the correct entry in the record has been found, the radar modulation parameters can be read out. The system is very reliable and cost efficient. Advanced versions are also able to predict an upcoming change of radar modulation parameters, which means that a radar target simulator system can be preemptively reconfigured to adapt to upcoming changes in radar modulation parameters. The radar modulation parameters determined in this manner may comprise any of radar signal bandwidth, chirp length, chirp period, chirp slope, chirp center frequency, antenna configuration, antenna activation and antenna transmission pattern. The proposed radar modulation parameter detection system is versatile in that the record can comprise any type of data, which is then indexed using the temporal power level profile.

According to aspects, the record also describes a repeating time sequence of modulation formats of the RUT. In this case the processing circuitry can be configured to determine a future modulation format of the RUT, based on the identified current modulation format of the RUT and on the repeating time sequence of modulation formats, where the radar modulation parameter detection system is arranged to output data indicative of the future modulation format of the RUT. This way upcoming changes in modulation parameters can be determined proactively, which is an advantage. One way to describe this type of repeating time sequence of modulation formats is to add pointers to the record entries which point to the next record entry in the time sequence. Thus, having identified a current modulation format, e.g., by its temporal power level profile, the next modulation format can be found in an efficient manner by following the pointer to the next record entry. The repeating time sequence of modulation formats of the RUT can be determined based on a recurrence analysis of a sequence of detected modulation formats of the RUT, as will be discussed in more detail below.

According to aspects, the processing circuitry is arranged to detect an onset and/or a cessation of transmission by the RUT, based on the determined temporal power level profile of the received radar signal, where the radar modulation parameter detection system is arranged to output a trigger signal indicative of the onset and/or the cessation of transmission by the RUT. The trigger signal can be used to, e.g., control various operations of a radar target simulator system. The trigger signal can also be used to control other auxiliary systems, as well as to collect data.

According to aspects, the temporal power level profile of the received radar signal and the temporal power level profile data entries in the record comprises a frame time duration measured from an onset of radar signal transmission to a cessation of radar signal transmission, where the onset and cessation of radar signal transmission is detected, e.g., using a power threshold and the frame time duration is determined using a timer or clock. Using frame time duration in this manner has shown to be a simple yet reliable way to identify the correct data entry in the record, and thus obtain the current radar modulation parameters in a reliable manner.

According to aspects, the temporal power level profile of the received radar signal and the temporal power level profile data entries in the record comprises at least one power threshold value, and a set of time instants when the received radar signal crosses the threshold. This is a simple yet reliable way to determine the temporal power profile data. Methods for robust configuration of thresholds are also discussed in detail herein.

According to aspects, the processing circuitry is configured to identify the current modulation format in use by the RUT by using a comparison metric that comprises a time duration of the temporal power level profile of the received radar signal and/or a power level of the temporal power level profile of the received radar signal and/or an amplitude pattern of the temporal power level profile of the received radar signal. These comparison metrics allow for the presence of noise and other disturbances. I.e., the output of the power detector does not need to be perfect in order to identify the correct set of radar modulation parameters in the record. The stability of the system is increased in this manner, especially in the presence of noise and other disturbances. The comparison between the determined temporal power level profile of the received radar signal and the temporal power level profile data entries in the record preferably comprises rising edge and/or falling edge threshold detection.

According to aspects, the radar modulation parameter detection system also comprises a modulation format detection sub-system that is arranged to identify radar modulation parameters in a radar modulation format. The processing circuitry can then be arranged to populate the record by the identified radar modulation parameters in an automated manner, which is an advantage, especially if the radar modulation parameters used by the RUT are unknown or partly unknown.

According to aspects, the record comprises at least two different sets of modulation formats, where each set comprises at least one modulation format, where the processing circuitry is arranged to select which set to use based on an external input signal associated with the RUT. This way external factors that influence the choice of modulation format by the RTS can be accounted for. The external input signal may for instance comprise any of a CAN bus signal, an Ethernet signal, or a FlexRay bus signal, and the external input signal may be indicative of a vehicle speed or a yaw rate of a vehicle 100.

According to aspects, the radar modulation parameter detection system is furthermore arranged to output a lock signal in case of successful identification of the current modulation format of the RUT among the at least two different radar modulation formats. This lock signal can be used to identify valid radar test data and distinguish the valid data from corrupt data obtained without lock, i.e., using the wrong radar modulation parameters.

Methods, radar test systems, radar target emulators and computer program products are also disclosed herein that are associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

With reference to the appended drawings, below follows a more detailed description of aspects of the disclosure cited as examples.

FIG. 1 shows a vehicle with an automotive radar system,

FIGS. 2A-E schematically illustrate some example radar waveform modulation formats,

FIG. 3 defines a number of example modulation parameters of an example radar waveform,

FIG. 4 shows an example radar test system in use,

FIG. 5 illustrates modulation detection for a radar controlled by an external input signal,

FIG. 6 illustrates modulation parameter detection and prediction,

FIGS. 7A-C illustrate different examples of temporal power level profiles,

FIGS. 8A and 8B show different example records comprising radar modulation formats,

FIG. 9 schematically illustrates an example of determining a temporal power level profile,

FIG. 10 illustrates a process for determining and validating a threshold value,

FIG. 11 shows a histogram of noise and signal samples for adjusting an initial threshold value,

FIG. 12 illustrates a process for determining a plurality of threshold values,

FIG. 13-14 schematically illustrates a frequency-based backscatter generation principle,

FIG. 15 illustrates time alignment between a mixer IF signal and modulation format changes,

FIG. 16 schematically illustrate example methods for testing and evaluating a response of an automotive radar system,

FIG. 17 is a schematic diagram of an exemplary computer system, and

FIG. 18 shows an example computer program product.

### DETAILED DESCRIPTION

The present disclosure will now be described more fully hereinafter with reference to the accompanying drawings, in which exemplary embodiments are shown. The disclosure may, however, be embodied in many different forms and should not be construed as limited to the embodiments set forth herein; rather, these embodiments are provided for thoroughness and completeness. Like reference characters refer to like elements throughout the description. Aspects set forth below represent the necessary information to enable those skilled in the art to practice the disclosure.

Automotive radars are used to increase safety and comfort in vehicles. They provide an accurate perception of the surroundings of the vehicle to be used by safety functions for life-saving decisions. Radars can measure distance, speed, angle (in both azimuth and elevation) and RCS (radar cross section) of the objects in the environment around the vehicle. The objects might be stationary (like road signs and other traffic infrastructure) or moving (such as other road users). Radars send radio waves into the environment using one or several transmitter (TX) antennas. The transmitted signal is often located at high frequencies, such as around 24 GHz or around 77 GHz. The radar signal interacts with one or more objects in the environment and the echo signal, often referred to as radar signal backscatter, is received by radar receiver (RX) antennas. The received signal is processed by the radar after down conversion and analog to digital conversion. When processing the received signal, signals from all receiver channels are processed and compared, to estimate the distance, speed, RCS, and angle of targets relative to the radar transceiver.

Radars are expected to provide high fidelity data. However, like most sensors, radars have physical and technological limitations, which impairs the performance.

To be able to evaluate, test and verify the performance of automotive radars, one needs to test them properly in scenarios that are as close to reality as possible. With radar target simulator (RTS) technology, the perception of targets can be generated virtually for the radar-under-test (RUT) in an over the air (OTA) manner. RTS systems are normally active devices operating in the same frequency band as the radars and in close vicinity of them, usually enclosed within an anechoic chamber. Most RTS systems for automotive radars create the perception of virtual target distance by receiving the radar signal and delaying it according to the expected distance. Another class of RTS systems work in frequency domain, and instead of delaying the radar signal, they apply a frequency shift representing such delay onto the radar transmit signal. Such RTS technology requires information about radar signal modulation in order to create the frequency perception of a target for the Radar Under Test (RUT) correctly.

An example of a frequency domain RTS system is described in WO 2017/069695 A1. At least some aspects of the techniques disclosed herein are applicable with this type of RTS and may also find use in other radar test applications, as will be discussed in more detail in the following. Automotive radars are used in multiple safety applications with different requirements. A certain radar system may be required to detect targets at larger distances in one application, for example in high-speed driving, while it also needs to measure a targets' range or speed at shorter distances with higher resolution when it is used in another application, for example at lower driving speeds. Such multi-purpose functionality of radars calls for different modulation parameters, i.e., that the radar system emits different types of waveforms depending on the operating scenario.

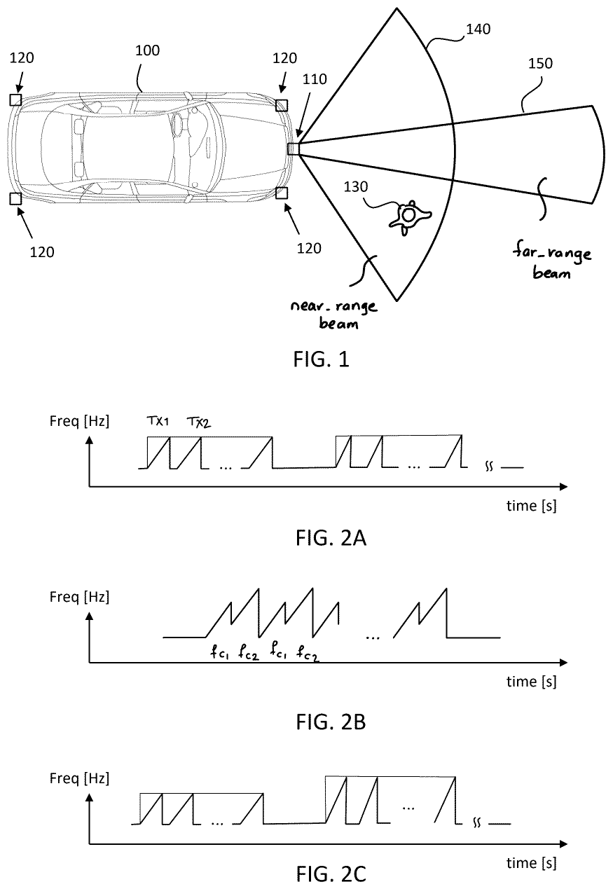

Frequency modulated continuous wave (FMCW) radar signals represent a well-known class of radar signal formats that are used by many automotive radars. An FMCW signal comprises a number of frequency sweeps, or chirps, that are commonly grouped into frames, where each frame is a transmission that has a well-defined onset and cessation of transmission. The FMCW signals can be adapted to have different bandwidths, different frequency sweep durations or chirp lengths, different sweep or chirp periods, different chirp slopes, different number of sweeps per frame, different chirp center frequencies, and so on, depending on the operating scenario and requirements placed on the radar system functionality. Some radar systems also use different antenna configurations or antenna beam patterns to illuminate far-range and near-range targets, as illustrated in FIG. 1. The configuration parameters of a radar transmission will be referred to herein as radar modulation parameters. Consequently, bandwidth, frequency sweep duration or chirp length, sweep period or chirp period, chirp slope, number of chirps per frame, chirp center frequency, antenna configuration, transmit antennas activation and transmission pattern, are all examples for radar modulation parameters. FIG. 3 shows some of radar modulation parameters.

Sometimes automotive radar systems use several different radar modulation parameters to improve the detection accuracy and reliability. Several sweep parameters may for instance be used in an FMCW-based system within one frame or in different frames. Different antennas may also be used within a frame with a certain pattern, for example a first transmit antenna may only be active during a first chirp transmission and a second transmit antenna may only be active during a second chirp transmission. The switch between transmit antennas can be done in a repeating pattern within a frame, or between frames.

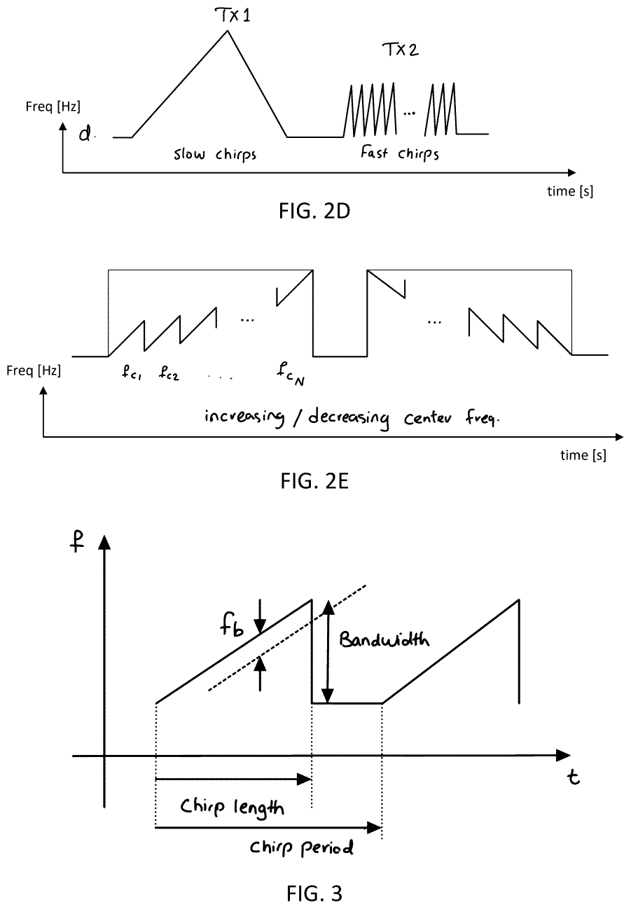

Several examples of radar transmission waveforms are given in FIGS. 2A-E. Each waveform is described by a corresponding set of radar modulation parameters depicted using frequency-time graphs.

FIG. 2A shows an example FMCW waveform, including two different frames, consisting of chirps with same bandwidth but different chirp slopes, different chirp lengths and chirp periods. The transmit antennas have a transmission pattern in which a first transmit antenna is active during chirps 1, 3, 5, . . . and a second transmit antenna is active during chirps 2, 4, 6, . . . .

FIG. 2B shows another example of FMCW waveform, where the center frequency is shifted between each two chirps.

FIG. 2C shows two FMCW frames with different bandwidth, different chirp slopes and chirp periods. It could be, for instance, related to far-range and near-range detections where more bandwidth is needed for high resolution detections by the radar in near-range.

FIG. 2D shows modulation features of FMCW waveform, including a frame with two long chirps commonly referred to as slow chirps, followed by a frame consisting of short chirps known as fast chirps. Each frame being transmitted by a different set of transmit antennas.

FIG. 2E shows FMCW waveforms with variable center frequencies within a frame.

FIG. 1 illustrates a vehicle 100 with a front radar 110 and a number of corner radars 120. The front radar 110 is arranged to generate a near range beam 140 and a far range beam 150, which have different detection properties and also represent different radar modulation parameters. A target, in this case a pedestrian 130, is detected by the near range beam 140 but not by the far range beam 150, in this example. Consequently, an RTS should ideally only generate a return signal in case the near-range beam 140 is being used, and not when the far-range beam 150 is being used. It is a purpose of the system disclosed herein not only to detect when a change in radar modulation parameters occurs, but also to predict what such changes are, and associate a correct set of radar modulation parameters with the detection of a change in radar operation. For the class of Radar Target Simulators (RTS), known as frequency-domain (modulation based) RTS, the modulation format and parameters of the radar-under-test (RUT) should be known. This is because the simulated targets are represented using their frequency signature that is depending on radar modulation parameters such as FMCW chirp information, see FIG. 3.

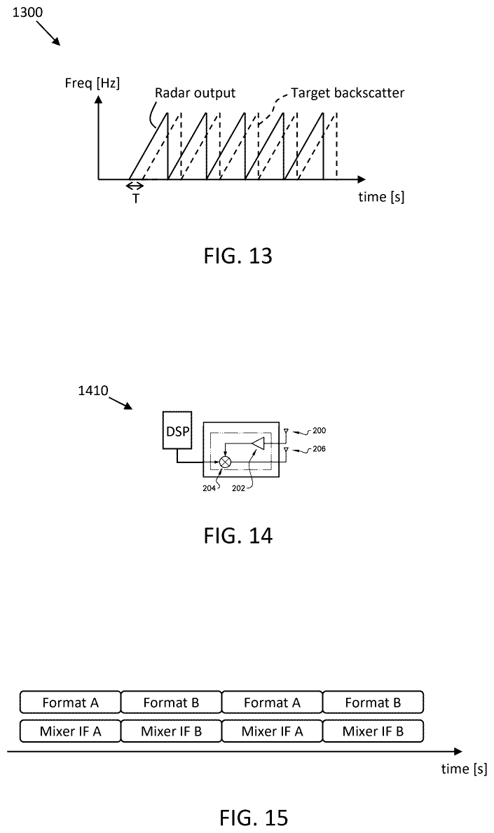

FIG. 13 shows an example of how a frequency-domain RTS can emulate the target giving rise to reflected radar backscatter at delay T (seconds), as shown in graph 1300. It is desired to emulate backscatter at delay T. This can be achieved using a design like that in schematic 1410 shown in FIG. 14. A receive antenna 200 receives the radar signal transmitted from the RUT, whereupon optional amplification 202 is applied. A digital signal processing device (DSP) determines a target signature to be applied to the received signal in order to emulate a target, such as the target at delay T. The target signature is input to a mixer 204, which adjusts the frequency of the received radar signal. This target signature is an approximate of the frequency difference between the radar transmit signal, and what that signal would look like had it been reflected by a target at delay T.

This way, with the knowledge of the radar modulation parameters, a frequency-domain RTS is able to calculate the frequency signature of simulated targets. However, any change in radar modulation parameters also causes a change in the frequency representation of targets, i.e., the input to the mixer 204 in order to make the target appear at the correct distance (and at the correct speed and/or angle). Consider for instance the case with a higher gradient chirp in the graph 1300, which would have resulted in a higher frequency IF signal input to the mixer in order to emulate the same target at delay T.

So, for radars with varying modulation parameters, the RTS preferably adapts its calculations of frequency signature to be applied at the mixer depending on which modulation parameters the radar is using currently. The detection of changes in modulation of radar and the adaptation of target's frequency signature should both happen in real-time during testing. This is illustrated in FIG. 15, where the RTS has two sets of modulation parameters, which can also be referred to as “modulation formats”: format A and format B. The RTS switches between them in a repetitive pattern. Note that the input to the mixer also switches between two frequency signatures in time alignment with the modulation changes of the RUT. Thus, as the RUT changes modulation format, e.g., to generate the near range beam and the far range beam discussed above in connection to FIG. 1, the emulated target will stay at the same distance, speed and/or angle.

Most automotive radars change their modulations with a certain pattern. So, the modulation change is in some way periodic. According to some aspects of this disclosure, the change in modulation parameters is predicted based on an observation of current modulation parameters (modulation format). With prior knowledge of the radar modulation pattern and current modulation parameters, the next modulation parameters can be predicted. This prediction is used by RTS to generate the desired frequency signature of simulated targets in real-time.

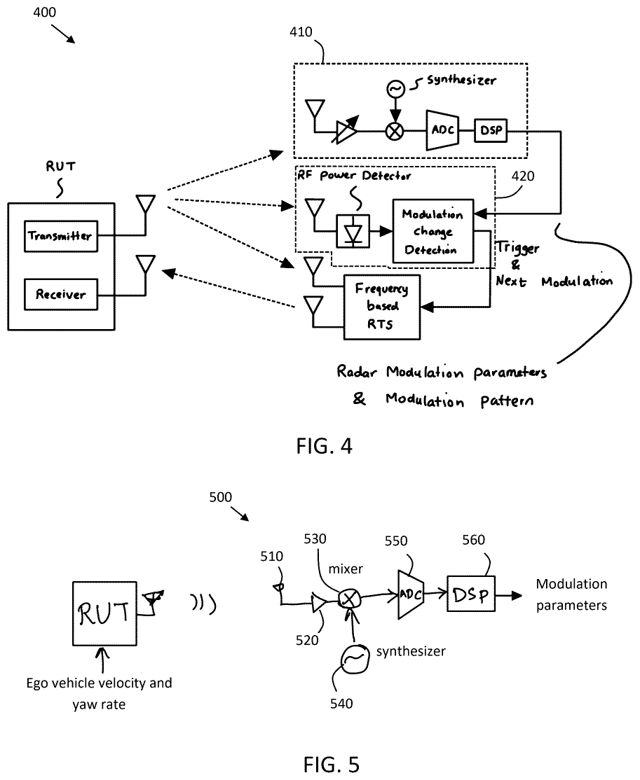

FIG. 4 shows an example 400 of an RTS system during testing of a RUT. The radar modulation parameters are, as discussed above, required for signal generation in frequency based RTS systems. The signal generation may, e.g., comprise generating an input signal to the mixer 204 discussed in connection to FIG. 14.

This information can, according to a first example, be provided by the designer/manufacturer of the radar. According to a second example, it is also possible to acquire such parameters by using a spectrum analyzer with transient measurement capability, i.e., a measurement device like an oscilloscope or spectrum analyzer with capability to perform time-frequency measurements of high frequency signals.

In the present disclosure, a third example of measuring radar modulation parameters is presented. The radar signal measurement is here performed in an over-the-air setup, as illustrated in FIG. 5. The method can either be used in a separate system for analyzing radar modulation or be integrated with the RTS as a subsystem which provides radar parameters during initial steps of an RTS operation.

With reference to FIG. 5, the RUT should be placed in front of this signal measurement system 500 comprising of the following elements:
Antenna 510, in the frequency band of the RUT, to receive the emitted signal from the radar.
Amplifier 520, to amplify the received signal from radar, optionally.
Mixer 530, to down convert the radar RF frequency to baseband or to IF.
Frequency synthesizer 540 for generating the center frequency into the mixer.
Analog to Digital Converter (ADC) 550 which converts the down-converted radar signal to digital,
Digital signal processor (DSP) 560 which processes the radar signal to extract the radar modulation parameters, such as modulation bandwidth, chirp slope, chirp duration and chirp period.

The DSP unit 560 executes an algorithm for processing the signal received from the RUT. This algorithm uses a time-spectrum analysis of the received signal such as Spectrogram or Wavelet transform which obtains the time evolution of the spectrum of the radar signal. The spectrogram is a 3D surface, where x-axis is time, y-axis is frequency and z-axis is amplitude/power. The radar signal appears as sawtooth-shaped waveforms in time-frequency plane, e.g., for FMCW radars, which correspond to a train of chirps. The extent of the signal in frequency domain reflects the bandwidth of the radar modulation. The periodicity of chirps in the sawtooth curve can be used to extract the chirp period, for example. The slope of the teeth in the sawtooth waveform is also a measure of chirp slope.

Observations of modulation parameters over consecutive frames enables to identify if the modulation parameters change repeats at a pattern and if so, also to identify that pattern, i.e., the repeating time sequence of modulation formats. For example, if the third frame of chirps has the same parameters (e.g., slope, chirp period, etc.) as the first one and the fourth frame is similar to the second measured frame, and this order is repeating, then it can be assumed known that the radar signal of the RUT follows a pattern including two frame types or two alternating modulation formats.

Some automotive radars vary their modulation depending on the ego-vehicle speed or yaw rate. In this case, the RUT could be triggered by a message over its communication bus (CAN, Ethernet, FlexRay, . . . ) so that the changes in modulation parameters of RUT due to the ego vehicle motion happen while the RUT is being measured. Here for each case where the modulation changes due to ego vehicle speed, a different set of modulation formats and their pattern is identified. For example, the RUT might use a set of three modulation formats for ego vehicle speeds below 60 kph and another set of four modulation formats when the vehicle is driven above 60 kph. All sets of modulation formats and patterns are stored in a record, which is used by the RTS to switch between modulation formats during testing of the RUT.

The modulation parameter detection system 420 in FIG. 4, identifies the current radar modulation parameters of RUT and also predicts future modulation parameters, i.e., the next modulation format of the RUT in time. This is done in real-time based on the pre-known/measured modulation pattern and modulation parameters in the record. As in FIG. 4, the system works in conjunction with the frequency based RTS 430 to generate the appropriate frequency signature of targets, which is adapting according to the radar modulation parameters as they vary over time. Thus, the modulation parameter detection system provides the timing of change in modulation parameters, in form of trigger signals, and the index to current or future modulation format from the record.

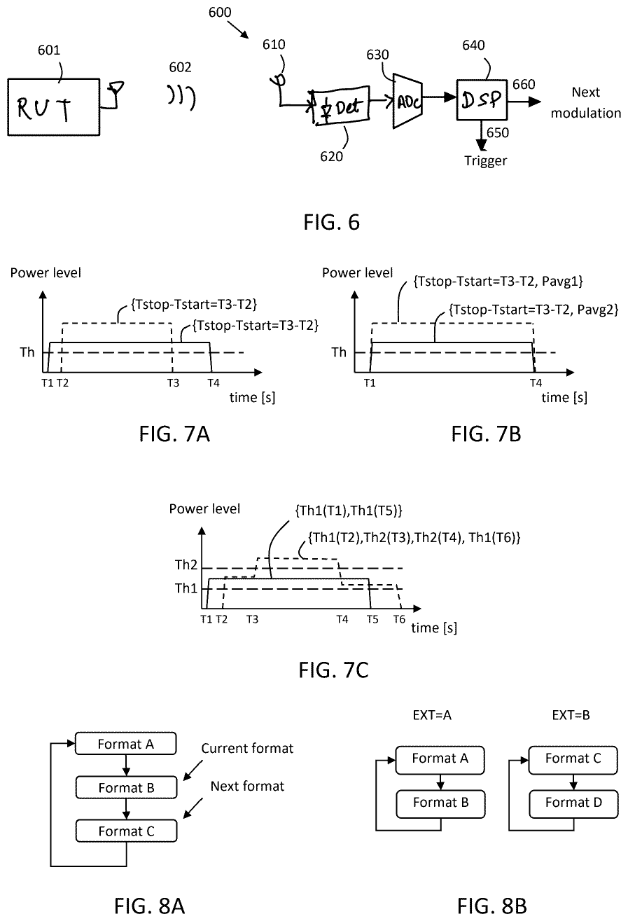

FIG. 6 schematically illustrates the radar modulation parameter detection system that receives the radar signal over-the-air and detects radar parameters that are currently in use by the RUT.

The system may also output data indicative of a future modulation format of the RUT which is emitted at a later point in time.

The system consists of the following hardware components:
Antenna 610, in the frequency band of the RUT.
RF power detector(s) 620, in the same frequency band as the radar signal.
ADC 630, which converts the detector signal to digital,
DSP 640, which comprises processing circuitry that does the processing of the radar signal received through the RF power detector.

The algorithm running on the DSP 640 enables the modulation change detection system to provide the information on when the next state in modulation pattern starts and/or when the current state in modulation pattern has ended, and which modulation parameters are corresponding to the current and/or future state, e.g., which frame type comes next. The system does this by determining a temporal power level profile of the received radar signal based on the output from the power detector 620 and uses this power level profile to find the correct entry in a record of different modulation formats associated with the RUT, i.e., modulation formats of the RUT. Each entry in the record is associated with a given temporal power level profile, featuring a frame length duration, a chirp length pattern, a chirp period pattern, an average power level, a power level transition pattern, or the like. The processing circuitry of the DSP can in this way identify the current modulation format of the RUT 601 among the at least two different radar modulation formats in the record, based on a comparison between the determined temporal power level profile of the received radar signal and the temporal power level profile data entries in the record.

FIG. 7A shows a first example where one modulation format has a temporal power level profile with a time duration from T1 to T4, and another modulation format with a time duration from T2 to T3. The two formats can be distinguished from each other based on the frame duration in this case, hence it is enough that the frame duration is used to index into the record to find the modulation parameters of each format. Thus, the system uses the temporal power level profile of the radar signal transmitted by the RUT to determine the modulation parameters in use by the RUT in an efficient manner with very small latency.

FIG. 7B shows an example where two modulation formats have the same frame duration, and thus cannot be distinguished using frame duration alone. In this case other aspects of the temporal power level profile can be used to index into the record to find the correct set of modulation parameters. In the example of FIG. 7B, average power of the radar signal is used instead of the frame duration.

A temporal power level profile may also comprise several threshold values, to distinguish the presence of each modulation format, and associated crossing time instants, as illustrated in FIG. 7C. This might be due to the transmit antennas activity of RUT. As these transmit antennas are located differently with respect to the antenna 610 connected to detector 620, different levels may appear in the power level profile of the received signal from each alternating antenna, for example.

It is appreciated that a power level profile may comprise any number of data items relating to the output of a power detector in combination with a timer or clock, such as total radar signal energy obtained as the integration over the power level, peak power level, and power level variation over the frame duration.

Each entry in the record comprises modulation parameters and can be identified using the temporal power level profile determined based on the output of the power detector 620. The record may also describe a repeating time sequence of modulation formats used by the RUT 601, i.e., the record entries may be connected to form a state machine as illustrated in FIG. 8A and in FIG. 8B. In this case the processing circuitry of the DSP 640 can be configured to determine a future modulation format of the RUT 601, based on the identified current modulation format of the RUT 601 and on the repeating (time) sequence of modulation formats.

FIG. 8B shows an example of modulation formats of RUT that may correspond to different ego vehicle speeds. In this case either of sets are used by the radar depending on ego vehicle speed. The radar modulation parameter detection system can use the record with all sets of modulation formats to identify the current modulation format of RUT, by comparing the power level profile of the received radar signal and the temporal power level profile of all data entries in the record, and accordingly identify which ego vehicle speed mode, A or B, the radar is in.

Alternatively, an external signal corresponding to the ego vehicle speed, for example, can limit the record to one set of modulation formats, so the radar modulation parameter detection system compares the temporal power level profile of received radar signal with the chosen set only.

In case the state machine is more complex than a simple repetitive pattern, it may be required to observe several modulation format changes to pinpoint the correct location in the state machine, i.e., in the time sequence of modulation formats. One way to solve this problem is to form hypotheses for each possible starting state in the state machine, and discard hypotheses which cannot be true over time as more and more modulation formats currently in use are identified.

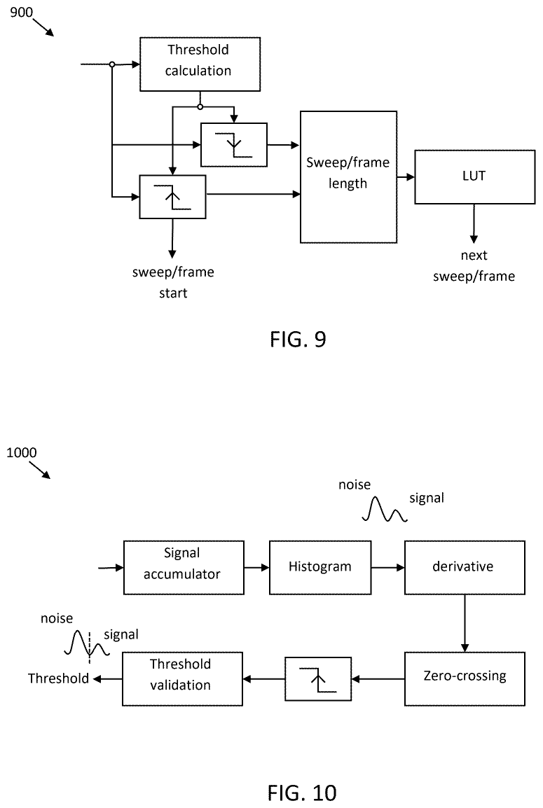

FIG. 9 illustrates the system 900 which determines frame start and frame end triggers and determines the frame length from the temporal power level profile of received signal to find the corresponding modulation format from entries in the record, as an example discussed above.

The algorithm includes at least the following steps:
1. A threshold is found for detecting where the radar signal exists in contrast to where it does not (i.e., only noise exists, for example in the interval between two frames).
2. The detector output is compared with the threshold to find where the radar signal begins and/or ends based on corresponding rising or falling edges,
3. A trigger signal is reported, indicating the beginning of the frame/chirp by looking for the rising edge (absence to presence of the radar signal)
4. A trigger signal is reported, indicating the end of a frame/chirp by looking for the falling edge (presence to absence of the radar signal). The falling edge for end of frame can be found only after a certain amount of time, that is the frame length, is passed.
5. The current frame length is found by comparing the time difference between rising and falling edges corresponding to the start and end of the frame,
6. The current chirp length is found from the chirp rising and falling edges,
7. The current chirp period is found from two consecutive chirp rising edges,
8. Either of frame length, chirp length or chirp period of current frame are compared with the temporal power delay profile data entries or modulation parameters in the record, which is here shown as a look-up table (LUT), to identify the current state in the radar modulation pattern. Using the modulation pattern, the system can predict the next expected modulation parameters.
9. The next modulation parameters (modulation format) as well as triggers (synchronization signals) are sent to the RTS to be utilized for target signature generation corresponding to the radar modulation parameters.
10. If the ego vehicle speed changes radar modulation during testing, the modulation change detection system identifies it with the same algorithm and predicts the next modulation parameters based on radar modulation pattern corresponding to the new ego speed.

A threshold is necessary to identify whether the radar signal is present or not, i.e., to determine the properties of the temporal power level profile. Having a good threshold is key for the modulation change detection algorithm to function properly. The placement of antenna detector might be such that not enough radar power is received by the system. In this case, a good threshold cannot be found. Finding a reliable threshold is possible given a good signal to noise ratio (SNR), which is very much affected by the placement of detector antenna. This can be identified by looking at the threshold, as explained further.

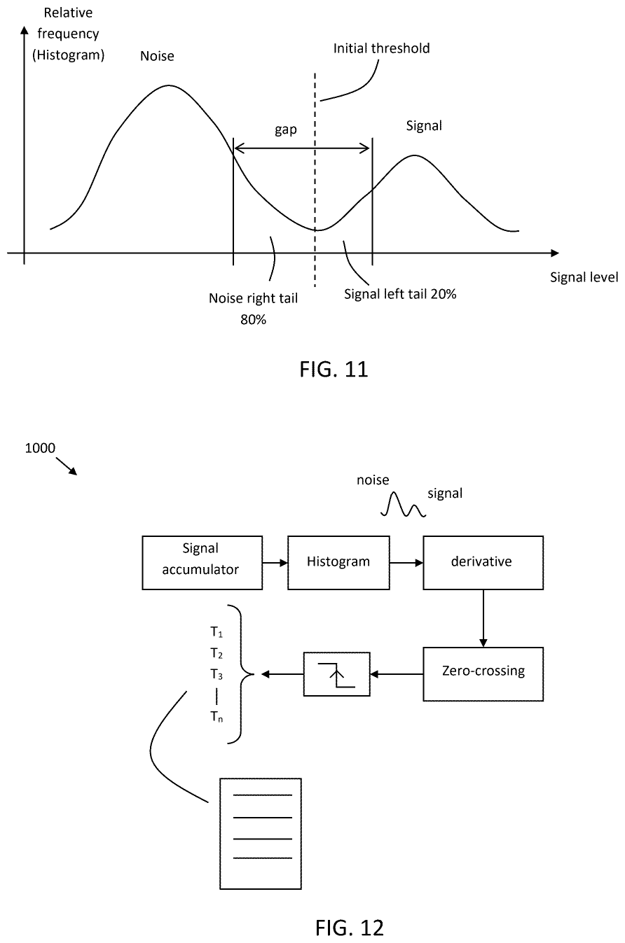

In this invention, we propose an algorithm which uses statistical information from one or more detector signals for finding the best possible threshold(s) and verifies if the SNR is good enough for the modulation change detection algorithm to function completely. FIG. 10 and FIG. 11 together illustrate an example of how a threshold configuration may be validated.
1. Digital signal processor receives samples of the detector's signal coming from ADC, such as the temporal power level profile discussed above. The number of acquired samples, i.e., the duration of this signal, is arranged so that all modulation patterns and intervals in between frames (noise) occur several times. This is to have better statistics.
2. A histogram for the level of the signal over all the acquired samples is created. The histogram provides an empirical estimate of the distribution of radar signal and noise amplitudes, appearing as two or more distinct peaks with valleys in between, depending on how distinct the signal and noise levels are. More than two peaks in this distribution of samples can be for example due to frames from different transmit antennas or different center frequencies received at different signal strength levels by the detector. The idea is to find the valley(s) as the threshold(s).
3. The threshold level is where there is a zero crossing in the derivative of the histogram,
4. If there is no direct zero-crossings, one can find the points in the derivative of histogram where a positive value follows a negative value. Here the threshold can be achieved by taking the average of these two points as the potential zero-crossing point. An early-late gate method can also be used to set the threshold.
5. From this initial threshold, a certain percentile of the left-tail of signal distribution as well as a certain percentile of the right-tail of noise-only distribution, specifies an interval. This interval is a measure of how good the SNR is. If the length of this interval is very small, it means signal and noise levels are not very distinct. The signal to noise ratio determined in this manner may not be deemed enough for the modulation detection algorithm to work with the initial threshold. Here a change in the setup, for example in the location of detector antenna, may help to alleviate the issue and repeating this process may lead to a better SNR for threshold finding.
6. If the SNR is considered enough, to improve the initial threshold, the mean value between the two percentiles in the last step is used as the new threshold value.

To summarize, aspects of the present teaching relate to a radar modulation parameter detection system 400 where the temporal power level profile is determined at least partly based on a comparison between the output of the power detector 620 and a threshold, as illustrated in FIG. 10 and in FIG. 11 and discussed above. The processing circuitry 640 can for instance be configured to determine the threshold based on a histogram of output samples from the power detector. According to some aspects the processing circuitry 640 is also configured to determine a signal-to-noise (SNR) value based on the histogram. The system can trigger a notification in case the SNR is too low, such that mitigating operations can be performed to improve the SNR. The system can also be set up to display the SBR during the test, and/or to record the SNR during a test to facilitate further analysis of the data.

If radars have changing bandwidth, center frequency or transmitting antennas, such changes appear as varying levels in the detector's output signal. For example, the radar signals coming from different transmit antennas of RUT are received with different strength at the detector. Similarly, changes in center frequency cause different levels at the detector's output signal. So, such variations reflect in the temporal power level profile of the received radar signal by the detector. These different levels in the detector's output signal create several valleys and peaks in the histogram of the detector's output signal. Here, the modulation change detection system can identify different types of frames by using more than one threshold value.

If such variations happen within a frame, it is possible to use one threshold to identify the start of the frame as well as knowledge of variation patterns to predict the time when changes in center frequency or the switching between RUT transmit antennas happens.

The threshold finding algorithm mentioned earlier, can be used for finding multiple thresholds. In such case, instead of finding one valley by looking for the zero-crossing of derivative of the histogram of the detector's output, n-1 zero-crossing needs to be found, where n is the number of different types of frames in the whole radar modulation.

In the case of radars with multiple transmitter antennas, they might switch between transmitter antennas. In certain placement of the detector antenna in front of the radar, not a good enough signal from all the radar's transmitter antennas might be received. This may be addressed by using two or more detectors with their antennas located geometrically apart in front of the RUT transmitter antennas. Now, a combination of detectors outputs may be used in different ways that contribute to the improvement of threshold finding or modulation change detection algorithm. For example, they can be combined simply by summing them together to have a stronger signal, or by combining (summing) a scaled version of each detector's output. This provides modulation change detection system with a more reliable signal to work with thanks to the spatial diversity.

There might be radars which do not follow a periodic pattern in their modulation parameter changes. This might be to reduce interference from other radars by using a sort of randomness. In this case, the radar modulation pattern based on previous sweeps/frames cannot be predicted. However, another system could be used for measuring sweep parameters such as chirp slope from few observations during a sweep or chirp. To calculate the slope of sweeps/chirps, one can deploy a method such as Instantaneous Frequency Measurement Receivers wherein, the phase of received signal with respect to its delayed version is calculated. With the knowledge of the fixed delay, one can calculate the frequency of that signal by dividing the delay by phase and multiplying it by 2 pi. So, with two samples of the signal with the known time in between during a chirp, we can estimate the bandwidth between the samples and consequently the chirp slope. Another method to identify the frequency of the signal is to use a bank of filters which provides a value corresponding to matching the signal to the most relevant filter.

To summarize, a radar modulation parameter detection system 420, 600, have been described. The system comprises an antenna 610 or at least an antenna port arranged to receive a radar signal 602 from a radar under test (RUT) 601. The type of antenna 610 may vary from implementation to implementation. Some realizations of the radar modulation parameter detection system may only comprise an antenna port, to which different types of antennas can be connected in order to perform various types of tests and performance characterizations involving different RUTs. Antenna arrays and single antennas are possible.

The system comprises a power detector 620, schematically shown in FIG. 6, which is arranged to determine a temporal power level profile of the received radar signal. A power detector is, generally, some form of device or system which determines the power or amplitude of a signal as a function of time. The power detector may be realized in hardware, or by a combination of hardware and software. For instance, a system comprising an ADC followed by processing circuitry implementing a squaring operation or absolute value function can be seen as a power detector, as can discrete diode-based pure hardware detectors, and so-called root-mean-square (RMS) power detectors that exploit nonlinear characteristics of MOSFET transistors to realize the RMS conversion. The term temporal power level profile is to be construed broadly herein to mean some form of power level pattern as function of time. Examples of temporal power level profiles comprise, e.g., radar frame durations measured as a time period with significant output from the power detector, average power level of the received radar signal, amplitude patterns of the received radar signal, and so on. Some example temporal power delay profiles were discussed above in connection to FIGS. 7A-C.

The radar modulation parameter detection system 420, 600 discussed herein also comprises processing circuitry 640 that is configured to obtain a record comprising at least two different radar modulation formats, where each radar modulation format in the record is associated with respective radar modulation parameters, and with respective temporal power level profile data entries. In other words, the processing circuitry has access to information regarding radar modulation formats that may be used by the RUT at some point in time. Each such modulation format is associated with some type of radar modulation parameter. It is these radar modulation parameters that can be used by an RTS to emulate targets, i.e., to configure the radar return transmission, as was discussed above. General processing circuitry of the type that can be used to realize the radar modulation parameter detection system herein is also discussed below in connection to FIG. 17.

The processing circuitry 640 is configured to identify a current modulation format of the RUT 601 among the at least two different radar modulation formats in the record, based on a comparison between the determined temporal power level profile of the received radar signal and the temporal power level profile data entries in the record. This means that the system checks to see which temporal power level profile data entry in the record matches the temporal power level profile detected by the power detector and uses the matching data entry to discover the current radar modulation format. Thus, the system uses a simple yet robust power detector to obtain a temporal power “fingerprint” of the current transmission, and then translates this fingerprint to modulation parameters via the record. Another way to see this is that a certain feature of the temporal power level profile of the received radar signal, e.g., the frame length, is used as a key to identify the correct radar modulation parameters in the record.

The actual record can be configured in various different ways. Manual configuration is one option, where an operator inputs radar modulation formats that can be used by a given radar system into a file, together with some type of temporal power level profile data entries for each modulation format. FIG. 4 shows the system for deployment of a radar target simulator (RTS) with RUT 400 with a number of different components. A key component is the radar modulation parameter detection system 420 that detects changes in modulation parameters of RUT and notifies the rest of the system of the change. Another component that may be advantageous to include in the target simulator is a modulation format detection sub-system 410 that is arranged to identify radar modulation parameters in a radar modulation format. The processing circuitry can then be arranged to populate the record by the identified radar modulation parameters. In this manner the record can be populated even if the modulation formats of the RUT are unknown, which is an advantage. This function can also be used separately for automated construction of the record used by the radar modulation parameter detection system.

The radar modulation parameter detection system 420, 600 outputs at least one radar test system control signal determined based on the current modulation format of the RUT 601. This control signal is also to be construed broadly to encompass anything from a trigger signal to a complete report of modulation parameters in use, statistics of the modulation parameters in use, and so on. The radar modulation parameters that can be obtained by the system in this manner may comprise any of radar signal bandwidth, chirp length, chirp period, chirp slope, chirp center frequency, antenna configuration, antenna activation and antenna transmission pattern.

Another way to describe the radar modulation parameter detection system is that the processing circuitry 640 is configured to obtain a record comprising at least two different radar modulation formats, where each radar modulation format in the record is associated with respective radar modulation parameters, and with respective temporal power level profile data entries, where the processing circuitry 640 is configured to identify a current modulation format of the RUT 601 among the at least two different radar modulation formats in the record, based on a one-to-one mapping between the determined temporal power level profile of the received radar signal and the temporal power level profile data entries in the record.

The record can also be used to describe a repeating time sequence of modulation formats of the RUT 601. The processing circuitry 640 can then be configured to determine a future modulation format of the RUT 601, based on the identified current modulation format of the RUT 601 and on the repeating time sequence of modulation formats, where the radar modulation parameter detection system 420, 600 is arranged to output data indicative of the future modulation format of the RUT 601. This means that the record can comprise an indication of a sequence of different formats of the RUT, and that the radar test system, knowing the sequence, can identify where in the sequence the RUT is and thus also predict what modulation formats that will be used in the future. Suppose for instance that the record contains three different modulation formats A, B and C, with three corresponding temporal power level profiles, such as different frame lengths or different power levels. Suppose further that the record comprises information that indicates that the sequence used by the RUT is {A, A, B, A, C} in a repeating manner. The processing circuitry can then use the output from the power detector, together with the information in the record, to identify where in the sequence the RUT currently is, i.e., in a way synchronize a point in the record with the action by the RTS. Once this synchronization has been achieved, the RTS is able to change modulation parameters in a proactive manner, thus allowing for radar testing of radar systems which change modulation parameters over time. The processing circuitry is optionally configured to determine the repeating time sequence of modulation formats of the RUT 601 based on a recurrence analysis of a sequence of detected modulation formats of the RUT. One such method of recurrence analysis is to perform a frequency analysis of a sequence of detected modulation formats and identify repeating patterns therein from a fundamental frequency. A correlation analysis using increasing blocks of detected modulation formats can also be used. Methods of determining the repeating time sequence in a sequence of samples are generally known and will therefore not be discussed in more detail herein.

According to some aspects, the processing circuitry 640 is arranged to detect an onset and/or a cessation of transmission by the RUT, based on the determined temporal power level profile of the received radar signal. The radar modulation parameter detection system 420, 600 can also be arranged to output a trigger signal indicative of the onset and/or the cessation of transmission by the RUT 601. The trigger signal can be used to control various operations of an RTS, such as to start re-transmissions or activate other functions. An example of this trigger signal can be seen in FIG. 4.

The temporal power level profile of the received radar signal and the temporal power level profile data entries in the record normally comprise a frame time duration measured from an onset of radar signal transmission to a cessation of radar signal transmission, as mentioned above. The onset and cessation of radar signal transmission can be detected using a power threshold and the frame time duration can be determined using a timer or clock. Methods for configuring thresholds were discussed above in connection with FIG. 10 and FIG. 11.

The temporal power level profile of the received radar signal and the temporal power level profile data entries in the record may comprise one or more power threshold values, and a set of time instants when the received radar signal crosses the threshold. This allows for more advanced power level profiles to be defined, based on more than one power threshold. A temporal power level profile may for instance comprise a first threshold which indicates onset and cessation of a radar frame transmission, with a part in the middle of the frame that comprises transmission of higher signal power. As discussed above, different power levels can also be indicative of a change in transmission antenna by the RUT since signals from different radar antennas to the antenna of the radar modulation parameter detection system 420, 600 are often associated with different levels of attenuation.

According to some aspects, the processing circuitry 640 is configured to identify the current modulation format in use by the RUT 601 using a comparison metric that comprises a time duration of the temporal power level profile of the received radar signal and/or a power level of the temporal power level profile of the received radar signal and/or an amplitude pattern of the temporal power level profile of the received radar signal. Thus, the radar modulation parameter detection system looks at the output from the power detector and compares this output to the different entries in the record using time duration and/or power levels. The comparison between the determined temporal power level profile of the received radar signal and the temporal power level profile data entries in the record may comprise rising edge and/or falling edge threshold detection, as discussed above.

The record may furthermore comprise at least two different sets of modulation formats, where each set comprises at least one modulation format, and where the processing circuitry may be arranged to select which set to use based on an external input signal associated with the RUT. The external input signal may, e.g., comprise any of a controller area network (CAN) bus signal, an Ethernet signal, or a FlexRay bus signal. The external input signal can for instance be indicative of a vehicle speed or a yaw rate of a vehicle 100. Thus, the radar modulation parameter detection system can be configured to listen to the same signal as the RUT and looks for modulation formats in the corresponding set of modulation formats based on the external signal. In this way an RTS can adapt its re-transmission in response to a change in operating state of the RUT before the change in operating state is even triggered. The RTS can, for instance, react to a change in speed and adapt retransmission radar modulation parameters in time alignment with the transmission by the RTS, which is an advantage. In a broad case, the radar modulation parameter detection system uses no external signal to identify the current set of modulation formats, but it uses the record to identify if the RUT has switched to another set of modulation formats. In case the matching between the temporal power level profiles of received signal and temporal power level profile data entries in one set is no longer happening, the system looks to find matching in all other sets in the record.

The radar modulation parameter detection system 400 can also be arranged to output a lock signal in case of successful identification of the current modulation format of the RUT 601 among the at least two different radar modulation formats. This lock signal can be used to tag output data from the RTS, thereby indicating validly obtained test results and distinguishing these valid results from invalid test data obtained without radar modulation format lock.

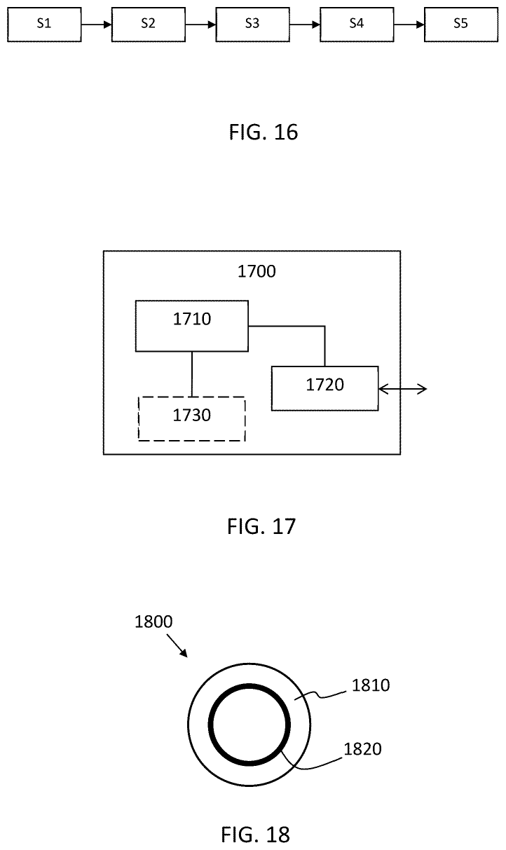

FIG. 16 illustrates a computer-implemented method which also summarizes the discussion herein. The method is performed by a radar modulation parameter detection system 420, 600, i.e., a system according to the description herein. The method comprises receiving S1, a radar signal 602 by an antenna 610 from a radar under test, RUT, 601, determining S2 a temporal power level profile of the received radar signal, by a power detector 620, obtaining S3, by processing circuitry 640, a record comprising at least two different radar modulation formats, where each radar modulation format in the record is associated with respective radar modulation parameters, and with respective temporal power level profile data entries, identifying S4, by the processing circuitry 640, a current modulation format in use by the RUT 601 among the at least two different radar modulation formats in the record, based on a comparison between the determined temporal power level profile of the received radar signal and the temporal power level profile data entries in the record, and outputting S5, by the radar modulation parameter detection system 420, 600, a radar test system control signal determined based on the current modulation format of the RUT 601.

FIG. 17 schematically illustrates, in terms of a number of functional units, the components of a control unit 1700 according to embodiments of the discussions herein. This control unit may be comprised in the devices and systems discussed above. Processing circuitry 1710, which may be distributed over several units, is provided using any combination of one or more of a suitable central processing unit CPU, multiprocessor, microcontroller, digital signal processor DSP, etc., capable of executing software instructions stored in a computer program product, e.g., in the form of a storage medium 1730. The processing circuitry 1710 may further be provided as at least one application specific integrated circuit ASIC, or field programmable gate array FPGA.

Particularly, the processing circuitry 1710 is configured to cause the control unit 1700 to perform a set of operations, or steps, such as the methods discussed in connection to FIG. 16 and elsewhere herein.

For example, the storage medium 1730 may store the set of operations, and the processing circuitry 1710 may be configured to retrieve the set of operations from the storage medium 1730 to cause the control unit 1700 to perform the set of operations. The set of operations may be provided as a set of executable instructions. Thus, the processing circuitry 1710 is thereby arranged to execute methods as herein disclosed. The control unit comprises processing circuitry 1710, an interface 1720 coupled to the processing circuitry 1710, and a memory 1730 coupled to the processing circuitry 1710, wherein the memory comprises machine readable computer program instructions that, when executed by the processing circuitry, causes the control unit to perform the methods discussed above in connection to FIG. 16.

The storage medium 1730 may also comprise persistent storage, which, for example, can be any single one or combination of magnetic memory, optical memory, solid state memory or even remotely mounted memory.

The control unit 1700 may further comprise an interface 1720 for communications with at least one external device. As such the interface 1720 may comprise one or more transmitters and receivers, comprising analogue and digital components and a suitable number of ports for wireline or wireless communication.

The processing circuitry 1710 controls the general operation of the control unit 1700, e.g., by sending data and control signals to the interface 1720 and the storage medium 1730, by receiving data and reports from the interface 1720, and by retrieving data and instructions from the storage medium 1730. Other components, as well as the related functionality, of the control node are omitted in order not to obscure the concepts presented herein.

FIG. 18 illustrates a computer readable medium 1810 carrying a computer program comprising program code means 1820 for performing the methods illustrated in FIG. 16, when said program product is run on a computer. The computer readable medium and the code means may together form a computer program product 1800.

1. A radar modulation parameter detection system, comprising:
an antenna arranged to receive a radar signal from a radar under test, RUT,
a power detector arranged to determine a temporal power level profile of the received radar signal, where the temporal power level profile is a power level pattern as a function of time,
and processing circuitry, wherein the processing circuitry is configured to obtain a record comprising at least two different radar modulation formats, where each radar modulation format in the record is associated with respective radar modulation parameters, and with respective temporal power level profile data entries,
wherein the processing circuitry is configured to identify a current modulation format in use by the RUT among the at least two different radar modulation formats in the record, based on a comparison between the determined temporal power level profile of the received radar signal and the temporal power level profile data entries in the record, and
wherein the radar modulation parameter detection system is arranged to output a radar test system control signal determined based on the current modulation format of the RUT.

2. The radar modulation parameter detection system according to claim 1, wherein the radar modulation parameters comprise any of; radar signal bandwidth, chirp length, chirp period, chirp slope, chirp center frequency, antenna configuration, antenna activation and antenna transmission pattern.

3. The radar modulation parameter detection system according to claim 1, wherein the record further describes a repeating time sequence of modulation formats of the RUT, where the processing circuitry is configured to determine a future modulation format of the RUT, based on the identified current modulation format of the RUT and on the repeating time sequence of modulation formats, where the radar modulation parameter detection system is arranged to output data indicative of the future modulation format of the RUT.

4. The radar modulation parameter detection system according to claim 1, wherein the processing circuitry is arranged to detect an onset and/or a cessation of transmission by the RUT, based on the determined temporal power level profile of the received radar signal, where the radar modulation parameter detection system is arranged to output a trigger signal indicative of the onset and/or the cessation of transmission by the RUT.

5. The radar modulation parameter detection system according to claim 1, wherein the temporal power level profile of the received radar signal and the temporal power level profile data entries in the record comprises a frame time duration measured from an onset of radar signal transmission to a cessation of radar signal transmission.

6. The radar modulation parameter detection system according to claim 5, where the onset and cessation of radar signal transmission is detected using a power threshold and the frame time duration is determined using a timer or clock.

7. The radar modulation parameter detection system according to claim 1, wherein the temporal power level profile of the received radar signal and the temporal power level profile data entries in the record comprises at least one power threshold value, and a set of time instants when the received radar signal crosses the threshold.

8. The radar modulation parameter detection system according to claim 1, wherein the processing circuitry is configured to identify the current modulation format in use by the RUT using a comparison metric that comprises a time duration of the temporal power level profile of the received radar signal and/or a power level of the temporal power level profile of the received radar signal and/or an amplitude pattern of the temporal power level profile of the received radar signal.

9. The radar modulation parameter detection system according to claim 1, wherein, where the comparison between the determined temporal power level profile of the received radar signal and the temporal power level profile data entries in the record comprises rising edge and/or falling edge threshold detection.

10. The radar modulation parameter detection system according to claim 1, comprising a modulation format detection sub-system arranged to identify radar modulation parameters in a radar modulation format, where the processing circuitry is arranged to populate the record by the identified radar modulation parameters.

11. The radar modulation parameter detection system according to claim 3, wherein the processing circuitry is configured to determine the repeating time sequence of modulation formats of the RUT based on a recurrence analysis of a sequence of detected modulation formats of the RUT.

12. The radar modulation parameter detection system according to claim 1, wherein the record comprises at least two different sets of modulation formats, where each set comprises at least one modulation format, where the processing circuitry is arranged to select which set to use based on an external input signal associated with the RUT.

13. The radar modulation parameter detection system according to claim 12, wherein the external input signal comprises any of a controller area network, CAN, bus signal, an Ethernet signal, or a FlexRay bus signal.

14. The radar modulation parameter detection system according to claim 12, wherein the external input signal is indicative of a vehicle speed or a yaw rate of a vehicle 100.

15. The radar modulation parameter detection system according to claim 1, arranged to output a lock signal in case of successful identification of the current modulation format of the RUT among the at least two different radar modulation formats.

16. The radar modulation parameter detection system according to claim 1,
wherein the temporal power level profile is determined at least partly based on a comparison between the output of the power detector and a threshold, and
wherein the processing circuitry is configured to determine the threshold based on a histogram of output samples from the power detector.

17. The radar modulation parameter detection system according to claim 16, where the processing circuitry is configured to determine a signal-to-noise, SNR, value based on the histogram.

18. A radar test system comprising a radar modulation parameter detection system according to claim 1.

19. A computer-implemented method performed by a radar modulation parameter detection system, the method comprising:
receiving, a radar signal by an antenna from a radar under test, RUT; and
determining a temporal power level profile of the received radar signal, by a power detector;
obtaining, by processing circuitry, a record comprising at least two different radar modulation formats, where each radar modulation format in the record is associated with respective radar modulation parameters, and with respective temporal power level profile data entries;
identifying, by the processing circuitry, a current modulation format in use by the RUT among the at least two different radar modulation formats in the record, based on a comparison between the determined temporal power level profile of the received radar signal and the temporal power level profile data entries in the record; and
outputting, by the radar modulation parameter detection system, a radar test system control signal determined based on the current modulation format of the RUT.
